(19) United States
(12) Patent Application Publication
(10) Pub. No.: US 2014/0222657 A1
(43) Pub. Date: Aug. 7, 2014

(54) Method and Application for Borrowers at Risk for Foreclosure and Participation in Regulated Home Affordability Program

(71) Applicants: Denise Wilhite-Thomas, San Ramon, CA (US); Michael Chan, Taipei (TW)

(72) Inventors: Denise Wilhite-Thomas, San Ramon, CA (US); Michael Chan, Taipei (TW)

(21) Appl. No.: 14/162,582

(22) Filed: Jan. 23, 2014

Related U.S. Application Data
(60) Provisional application No. 61/755,720, filed on Jan. 23, 2013.

(51) Int. Cl. G06Q 40/02

(52) U.S. Cl. CPC G06Q 40/025
USPC 705/38

(57) ABSTRACT

A method to identify potential borrowers/homeowners/applicants who are at risk of foreclosure and determine whether said borrower/homeowners/applicants are eligible for the National Making Home Affordable Program or other regulated loan modification program.

### RELATED APPLICATION(S)

This application is a Non-provisional application of and related to pending U.S. Provisional Patent Application Ser. No. 61/755,720 filed Jan. 23, 2013 entitled “METHOD AND APPLICATION FOR BORROWERS AT RISK FOR FORECLOSURE AND PARTICIPATION IN REGULATED HOME AFFORDABILITY PROGRAM”; which is incorporated herein by reference in its entirety. This application claims any and all benefits to which it is entitled therefrom.

### FIELD OF THE INVENTION

The present invention relates to a method and application for determination and processing loan financing program, and more particularly, a software application to identify borrowers potentially at risk of foreclosure and for determination of process accuracy and eligibility for the national Making Home Affordable Program (hereafter “HAMP”) or other Federally or locally regulated home affordability program, and more particularly to an online interactive information terminal to collect relevant and important information needed to determine the possibility of retracting foreclosure on a property.

### BACKGROUND OF THE INVENTION

The Making Home Affordable Program (MHA) is a broad strategy to help homeowners avoid foreclosure, stabilize US's housing market, and improve the nation's economy. There are a number of options for homeowners to choose the best program that suits their situations, including:
Home Affordable Modification Program (HAMP)
Principal Reduction Alternative SM (PRA)
Second Lien Modification Program (2MP)
FHA Home Affordable Modification Program (FHA-HAMP)
USDA's Special Loan Servicing
Veteran's Affairs Home Affordable Modification (VA-HAMP)
Home Affordable Foreclosure Alternatives Program (HAFA)
Second Lien Modification Program for Federal Housing Administration Loans (FHA-2LP)
Home Affordable Refinance Program (HARP)
FHA Refinance for Borrowers with Negative Equity (FHA Short Refinance)
Home Affordable Unemployment Program (UP)
Hardest Hit Fund (HHF)

HAMP:

The target of HAMP is 7 to 8 million struggling homeowners at risk of foreclosure by working with their lenders to lower monthly mortgage payments. The Program is part of the Making Home Affordable Program which was created by the Financial Stability Act of 2009. The program was built as collaboration with lenders, investors, securities, mortgage servicers, the FHA, the VA, FHLMC, FNMA, and the Federal Housing Finance Agency, to create standard loan modification guidelines for lenders to take into consideration when evaluating a borrower for a potential loan modification.

HAMP may lower monthly mortgage payments for homeowners who are eligible for the program in order to make them more affordable and sustainable for the long-term.

Homeowners who want to enroll in the HAMP must put in their application and go through a evaluation process which is governed by a number of eligibility requirements. The followings are a partial list of the requirements:
Loans originated on or before Jan. 1, 2009
First-lien loans on owner-occupied properties with unpaid principal balance up to $729,750
Higher limits allowed for owner-occupied properties with 2-4 units
The current principal, interest, property taxes and homeowner's insurance payments are costing the borrower(s) over 31% of their gross monthly household income.
All borrowers must fully document income, including signed IRS 4506-T, proof of income (i.e. paystubs or tax returns), and must sign an affidavit of financial hardship
Property owner occupancy status will be verified through borrower credit report and other documentation; no investor-owned, vacant, or condemned properties
Incentives to lenders and servicers to modify at-risk borrowers who have not yet missed payments when the servicer determines that the borrower is at imminent risk of default
Modifications can start from now until Dec. 31, 2012; loans can be modified only once under the program

Due to the relatively complex application process and eligibility requirements, some homeowners and even banks and counselors find it difficult to navigate the application by themselves and determine whether the homeowners are eligible for the program or more suitable for other MHA programs.

There are non-profit organizations and for profit companies/agents offer assistance to homeowners in various degree to navigate and apply for the HAMP. There are no realtime mobile application for this purpose currently in the market.

### SUMMARY OF THE INVENTION

The present invention is a method, and more specifically a software and/or a mobile application for identification of borrowers at risk for foreclosure and for determination of process accuracy and eligibility for participation in HAMP and/or other MHA programs and/or local regulated home affordability programs.

One object and advantage of the present invention is to provide a convenient and low cost way for potential HAMP applicants to find out their eligibility before investing more time and money into the application process.

Another object and advantage of the present invention is to provide users a secure and private way to check their eligibility.

Another object and advantage of the present invention is to provide a non-committal way to start the application process of HAMP.

Another object and advantage of the present invention is to provide a way to replace or partly replace a lengthy in-person interview process between consultants and users to yield the same information regarding users' loan and foreclosure details. Additionally, consultants do not have to record interview answers.

Another object and advantage of the present invention is to provide a common platform for various parties including homeowners, banks, counselors, etc. who are involved in the HAMP application process to share, input, review, cross-check and exchange information in a realtime manner.

Further details, objects and advantages of the present invention will become apparent through the following descriptions, and will be included and incorporated herein.

The invention possesses other objects and advantages especially as concerns particular characteristics and features thereof which will become apparent as the specification continues.

### BRIEF DESCRIPTION OF THE DRAWINGS

FIG. 1 is a representative flowchart illustrating logistics of one embodiment of the present invention 100.

FIG. 2 is a representative view of one example of online interactive interview questionnaire of the present invention 100.

FIG. 3 is a representative flowchart of mobile application 200 of the present invention 100.

FIG. 4 is a representative schematic illustrating data flow logistics of mobile application 200 of the present invention 100.

FIGS. 5A-5D are representative screen shots of mobile application 200 of the present invention 100.

FIG. 6 is a representative screen shots of applicant's report of mobile application 200 of the present invention 100.

### DETAILED DESCRIPTION OF THE PREFERRED EMBODIMENT

The description that follows is presented to enable one skilled in the art to make and use the present invention, and is provided in the context of a particular application and its requirements. Various modifications to the disclosed embodiments will be apparent to those skilled in the art, and the general principals discussed below may be applied to other embodiments and applications without departing from the scope and spirit of the invention. Therefore, the invention is not intended to be limited to the embodiments disclosed, but the invention is to be given the largest possible scope which is consistent with the principals and features described herein.

Purpose:

The goal of the present invention 100 is to identify errors in the processing of eligibility of borrowers for the HAMP and/or other Making Home Affordable Programs and/or other regulated, mandated or proprietary loan modification program and determine whether they are at risk of foreclosure.

### INTRODUCTION

Product Name: BAR Version: 1.01

The present invention 100 outlines specification for development of software to identify borrowers at risk for foreclosure and determination of process accuracy and eligibility of HAMP or other Federally or locally regulated home affordability program.

In one embodiment, the specification includes Interface, internal process protocol, end user notification and termination procedures.

Development audience to include software design and development teams.

Test Plans to be derived during developmental phase.

System Overview:

Software will be applicable to all major platforms including current versions of Windows, Macintosh and mobile based platforms such as Android, IOS, etc. Software can be downloaded directly from secure websites, Google Play, Apple App Store or via CD ROM.

Design Considerations:

Software will function on the following platforms (listed by order of development priority):

### 1. Windows

### 2. Internet Explorer [IE];

### 3. Macintosh; and

4. Mobile device operating system such as Android, IOS, etc.

Software updates will be made available for downloading directly from secure websites or via CD ROM.

Target Users:

End users are catered for non-technical savvy adults. Target users are most likely in the industries of banking, real estate, legal, government and/or financial communities. It will be understood that for each type of target user, there may be a unique graphical user interface (GUI) for that class of target user. Thus, the software application will have a GUI for the borrower target user, a separate GUI for the loan modification specialist or consultant advising the borrower, a separate GUI for the lender or mortgage originator, and possibly a separate GUI for the loan servicing agent. There may also be a separate GUI for regulators, such as for review for compliance with various multi-state settlement agreements, compliance with federal programs, compliance with equal opportunity, equal rights and non-discrimination laws and policies, and possibly a separate GUI for federal government agencies and NGOs monitoring compliance of lenders and mortgage servicing agents with any of the various applicable rules and regulations and programs.

Architectural Strategies:

The architecture strategy should include:
Secure Access and Exit
Client Login
Integrated User Help
User Friendly Interface
Clear and Concise Flow
System Logout

Example Showing Detailed System Design:

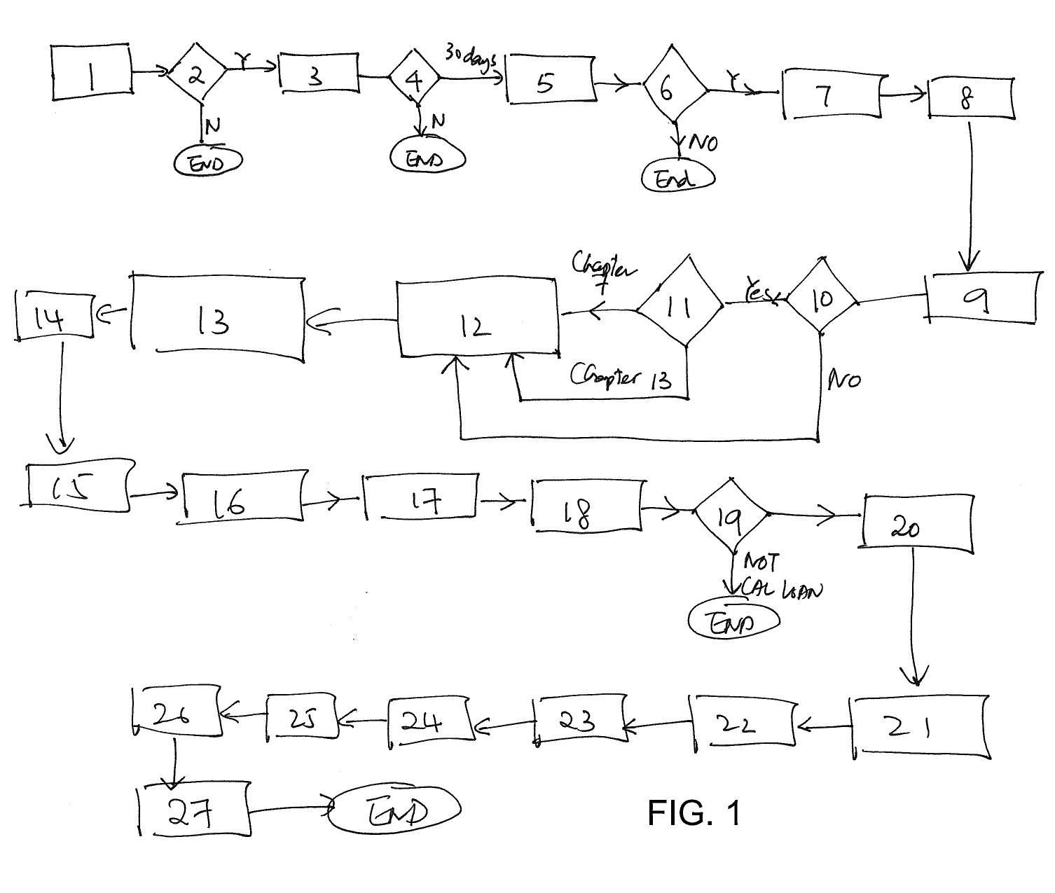

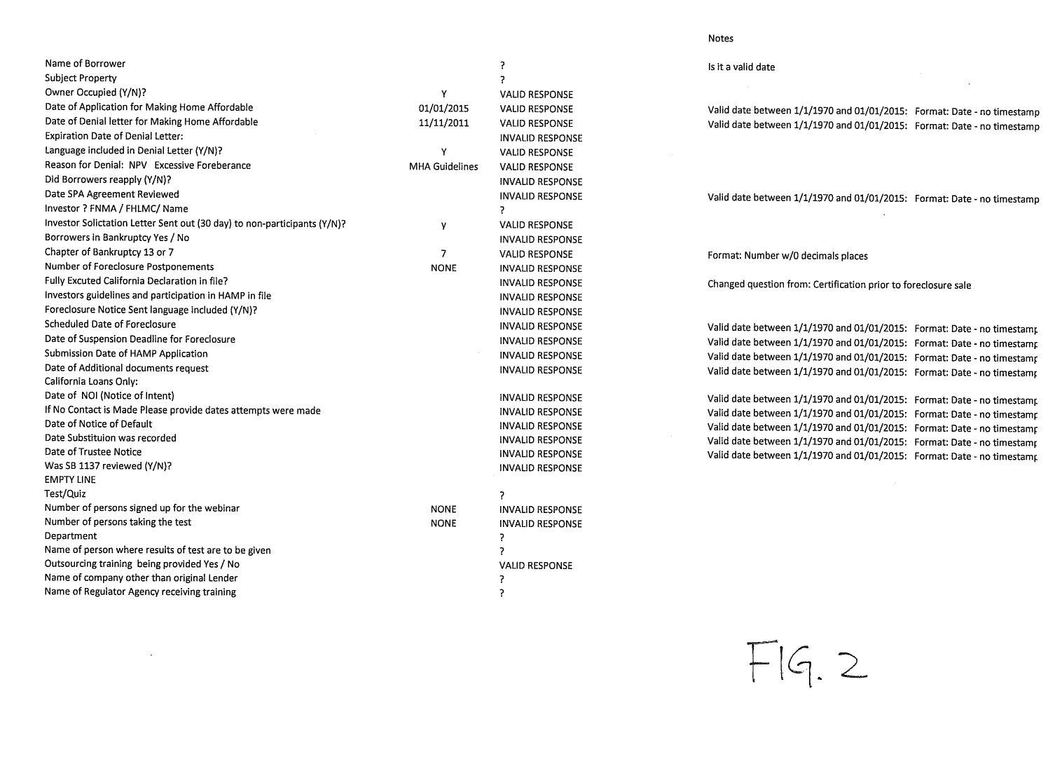

FIG. 1 is a representative flowchart illustrating logistics of one embodiment of the present invention 100. FIG. 2 is a representative view of one example of online interactive interview questionnaire of the present invention 100. As shown in FIG. 1, system design should include but not limiting to the following input/output:

| INPUT | OUTPUT |
|---|---|
| Name of Borrower: [1] | |
| Subject Property [1] | No more than 4 Units |
| Owner Occupied [2] | YES: Mandatory requirement: |
| | Cannot proceed if NO |
| Date of Application for Making Home | Field must be completed |
| Affordable [3] | |
| Date of Denial letter for Making Home | Field must indicate 30 days from date on letter |
| Affordable [4] | |
| Expiration Date of Denial Letter: [5] | Field must match expiration date on |
| | denial letter |
| Language included in Denial Letter Yes/No [5] | Mandatory field: Directive 10-02 Clear language |
| | stating that during the HAMP |
| Reason for Denial: NPV Excessive Forbearance [5] | Mandatory Field Borrower allowed to reapply |
| Did Borrowers reapply Yes/No [6] | Mandatory Field date of re-application must be |
| | entered 30 days begins again |
| SPA Agreement Reviewed [7] | Date Investor agreement reviewed for |
| | participation in HAMP |
| Investor? FNMA/FHLMC/Name [8] | Mandatory Field |
| Investor Solicitation Letter Sent out (30 day) to | Mandatory Field Date letter sent out to non- |
| non-participants [9] | participants |
| Borrowers in Bankruptcy Yes/No [10] | Mandatory Field |
| Chapter of Bankruptcy 13 or 7 [11] | Mandatory Field Borrower considered for |
| | HAMP yes/no |
| Number of Foreclosure Postponements [12] | [Numeric answer] |
| Certification prior to foreclosure sale [12] | Mandatory Field Reason on Lenders Declaration |
| Investors guidelines and participation in HAMP | Yes or No |
| in file [13] | |
| Foreclosure Notice Sent language included | Mandatory Field Borrowers must be completely |
| Yes/No [14] | out of HAMP |
| Scheduled Date of Foreclosure [15] | Mandatory Field Date must be 30 days after lines |
| | 7 and 10 if date is prior cannot move on |
| Date of Suspension Deadline for Foreclosure [16] | MHA documents received prior to 7 days to |
| | foreclosure per 10-02 foreclosure must be halted |
| Submission Date of HAMP Application [17] | Mandatory Field |
| Date of Additional documents request [18] | Mandatory Field |
| California Loans Only: [19] | Period covered Jan. 1, 2003 to December 2008 |
| Date of NOI (Notice of Intent) [20] | Mandatory Field Date contact made with borrower |
| If No Contact is Made Please provide dates | Mandatory Field |
| attempts were made [21] | |
| Date of Notice of Default [22] | Mandatory Field |
| Date Substitution was recorded [23] | Mandatory Field |
| Date of Trustee Notice [24] | Mandatory Field |
| Was SB 1137 reviewed? [25] | Mandatory Field |
| Test/Quiz [26] | |
| Number of persons signed up for the webinar [27] | |
| Number of persons taking the test Department [27] | |
| Outsourcing training being provided Yes/No [27] | |
| Name of company other than original Lender [27] | |
| Name of Regulator Agency receiving training [27] | |

Supplemental Directive 11-06 Updates For Loan Servicers Jul. 6, 2011)
Prohibition Against Special
Special Collection: Collections Measures

Following a Loan Servicer's standard collection efforts and during consideration of a borrower for HAMP or other loan modification program, lenders and/or Loan Servicers may not take additional collection measures for the purpose of reducing the delinquency period in order to qualify for a higher up-front Loan Servicer incentive. These additional efforts include but are not limited to, requesting or requiring borrowers to make past due payments, bringing a loan less delinquent through capitalization, or deferral or forgiveness of payments. MHA-Compliance will perform testing of loan payment histories to ensure that such activities do not occur.

Completed Modification Incentive A Loan Servicer will receive MHA Handbook Mapping compensation in accordance with the following chart Number of days delinquent at Trial Payment (or Period) Plan (TPP) effective Date Less than or equal to 120 days delinquent (150 days from last full paid installment (LPI) date) Incentive Pay $1,600.00 121 days or more delinquent to and including 210 days delinquent (151 to 240 days from LPI date) incentive pay $1200.00 Greater than 210 days delinquent (greater than 240 days from LPI date $400.00

For permanent HAMP modifications with trial period plan effective dates on or after the Supplemental Directive Effective Date, the additional $500.00 compensation payable to the Loan Servicer if a borrower was current under the original mortgage loan is eliminated.

Supplemental Directive 10-15 MHAP Case Escalation Process/Dodd-Frank ACT NPV Notices

Servicer Escalated Case Management:

All Loan Servicers are required to have written procedures and personnel in the place to provide timely and appropriate responses to borrower inquires and disputes that rise to the level of an “Escalated Case,” which includes, but is not limited to:
Allegation that the Loan Servicer did not assess the borrower for the applicable MHA Program(s) according to program guidelines;
Inquiries regarding inappropriate program denials or the content of a Non Approval Notice; Initiation or continuance of foreclosure actions in violation of program guidelines; or
Cases referred to the Loan Servicer by HSC and MHA Help.

The Loan Servicer may handle Escalated Cases received from HSC, MHA Help, a borrower, an authorized advisor, Treasury, other federal agencies or elected officials (each, a Requestor).

Mobile Application 200:

The mobile application 200 of the present invention 100 is in an online interactive information terminal and step by step guided interview which is adapted and compatible to mobile devices and their respective operating system such as Android, IOS, Windows Mobile, etc. Mobile application 200 gives users the convenience and fast response needed to evaluate the foreclosure situation of their properties and also to banks and counselors to better appraise the eligibility of homeowners' applications. Mobile application 200 is able to collect the relevant and important information needed to determine the possibility of retracting the foreclosure on a property.

Mobile application 200 is an online mobile application. The information and interactive forms are updated real time. This allows current laws, regulations and polices to be updated immediately.

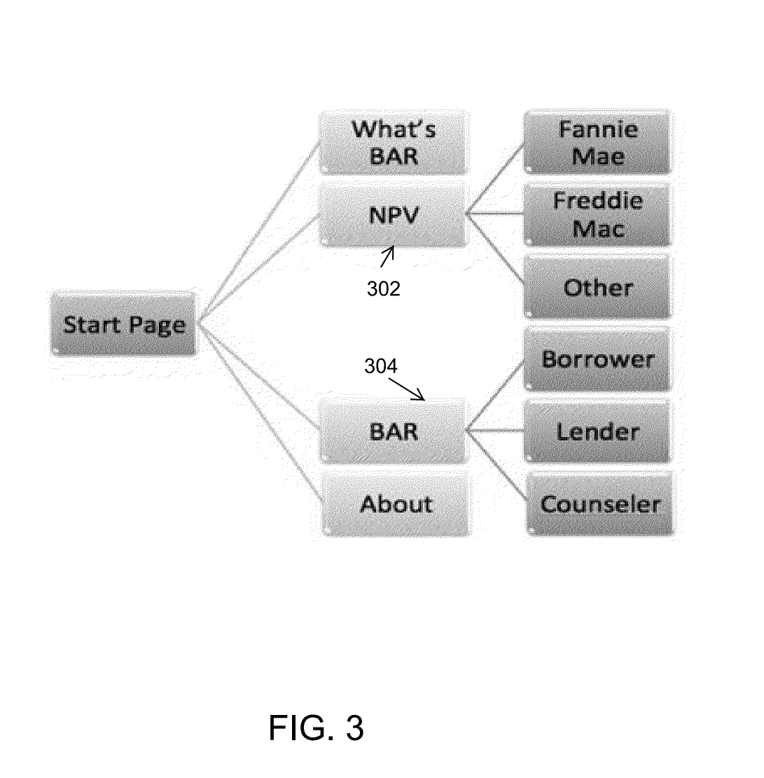

FIG. 3 is a representative flowchart of mobile application 200 of the present invention 100. As shown in FIG. 3, mobile application 200 has two main groups of users and each of them will be responding to their respective interview questionnaire, viz. Net Present Value (NPV) interview and Borrowers At Risk (BAR) interview. NPV interview is mainly targeted to financial/mortgage institution like Fannie Mao, Freddie Mac, and others while BAR interview is mainly targeted to homeowners (borrowers), banks (lenders) and counselors. Users will identify their role at the beginning and will be given their appropriate set of questions subsequently.

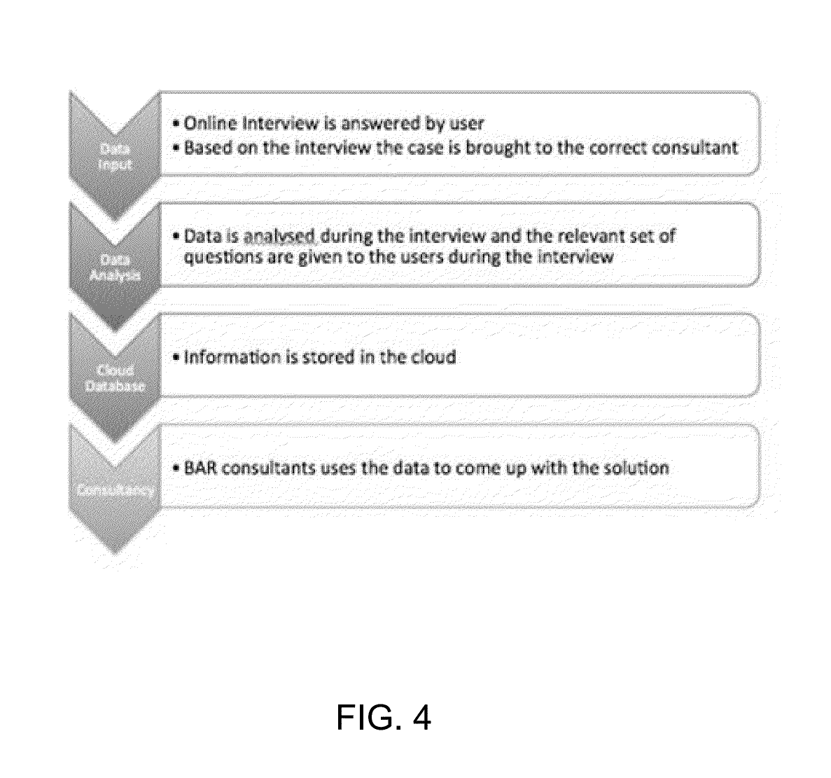

FIG. 4 is a representative schematic illustrating data flow logistics of mobile application 200 of the present invention 100. As discussed, users will identify their role and be given a specific set of interview questions which are adjusted in realtime according to the latest laws, rules and regulations governing the loan and HAMP, and/or other loan modifications programs. After that, inputted data will be analyzed and stored in the cloud. Consultants of the mobile application 200 will then retrieve analyzed data and reports from the cloud. Based on their expertise, each case will be evaluated by consultants and the results including HAMP eligibility, eligibility of other loan modification programs like MHA programs, and recommendations will be given to users.

Mobile application 200 uses keywords, choices and logic to determine the flow of the interview given to specific users.

In one embodiment, mobile application 200 is made up of the following modules

a. Online Interactive Interview
b. Realtime Information System
c. Realtime Notification System
d. Reporting System

Online Interactive Interview:

This process utilizes the scenario database compiled by BAR/NPV consultants to generate a user centered interview and collects very pertinent and relevant data. During the interview, keywords, scenarios are analyzed and the direction of the interview changes according to the responses of the user. This data is then used by the BAR/NPV consultant to come up with a solution for the foreclosure victim.

Realtime Information System:

By making mobile application 200 an online system, it is possible to present current and realtime information which may be useful to help users in their fight to recover a foreclosure property.

Realtime Notification System:

It allows mobile application 200 consultants to notify all or specific users on advice, news, warning etc. which is crucial in the time sensitive fight to save a property from foreclosure.

Reporting System:

A realtime reporting system allows mobile application 200 consultants to respond to interviews the minute it is submitted.

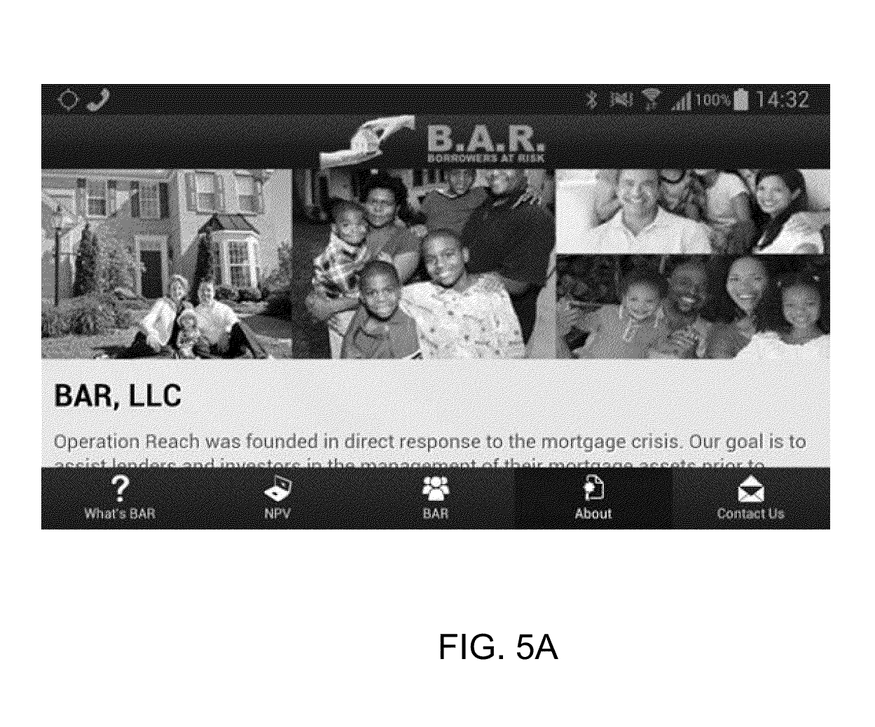

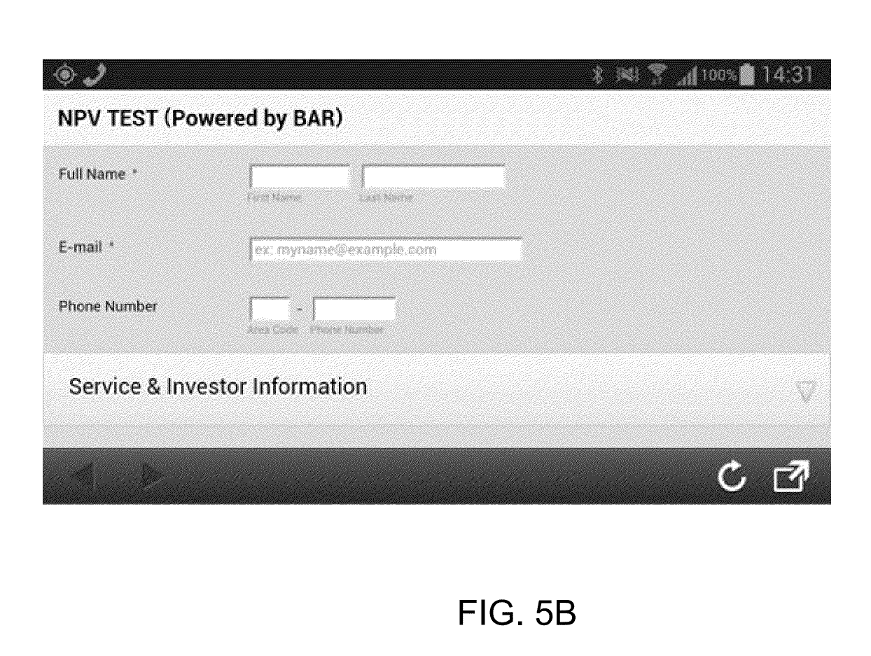

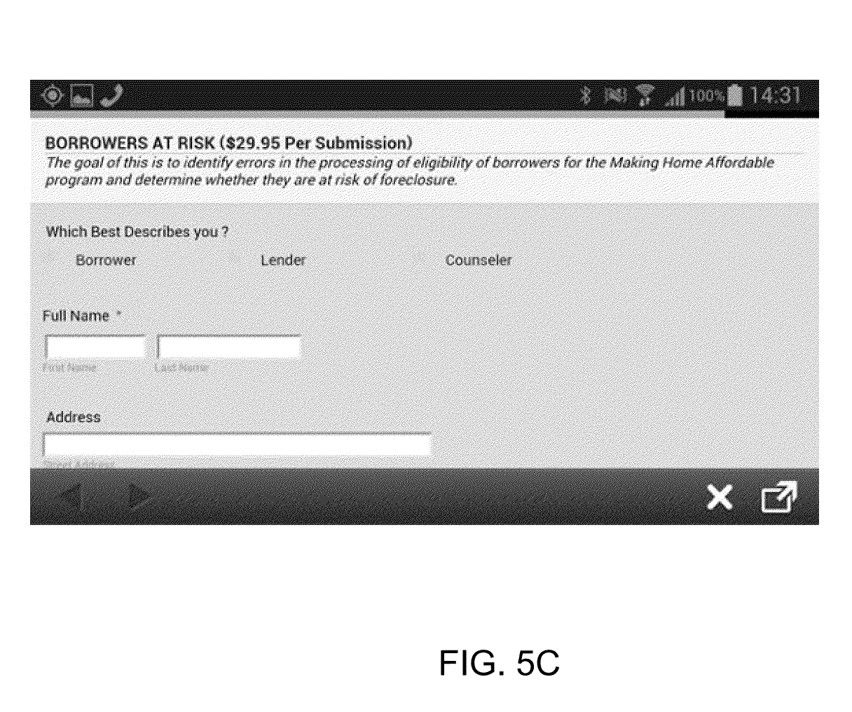

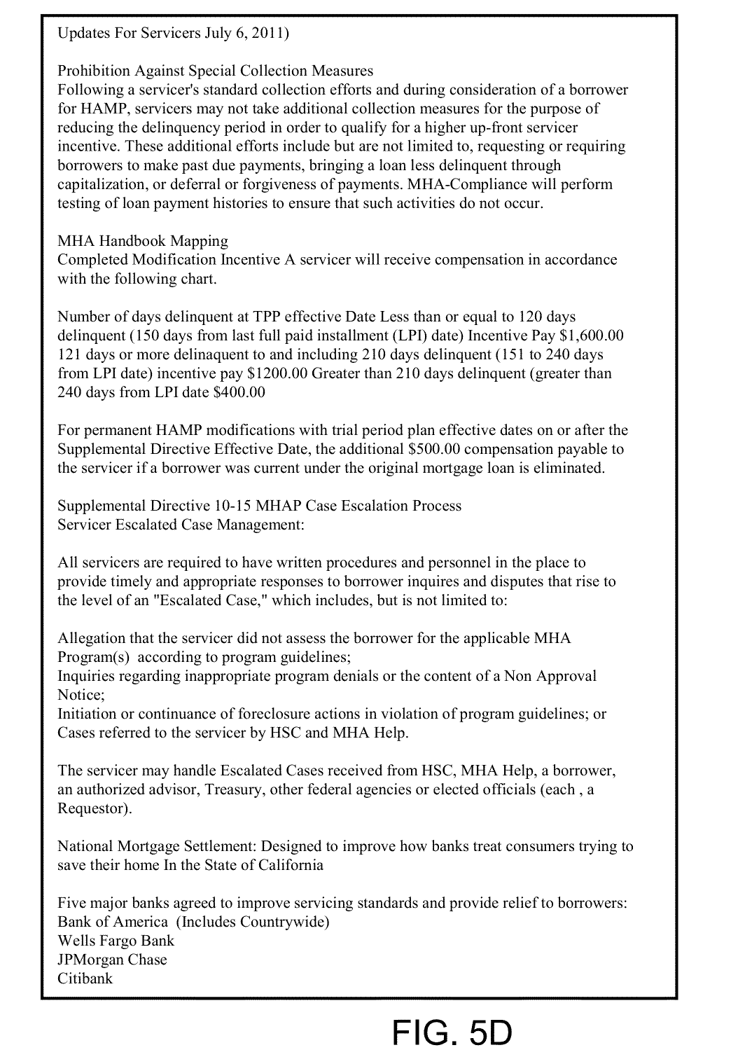

FIGS. 5A-5D are representative screen shots of mobile application 200 of the present invention 100. As shown in FIGS. 5A and 5D, users are given general information about MHA programs, BAR, NPV and other useful information before they start the realtime online interactive interview. The information given will help users to better identify themselves so they can get the appropriate interview. In FIG. 5B, NPV users will enter their information and identification. In FIG. 5C, BAR users will enter their information and identification. Mobile application 200 will then analyze their input and navigate them to a right set of realtime online interactive interview. In one embodiment, measures will be installed to make sure that users identify themselves correctly.

Once users' identification is verified, they will be navigated to a set of specific questions which are pertinent most to their situation. Questions content, flow and sequence will be adjusted in realtime based on answers given, latest laws, rules and regulations and users' preference. Most questions are close-end so users can pick their answers within the given choices by click a box on their mobile devices. Answers for open-end questions will be given a space to type in their answers.

A Sample Questionnaire for BAR users:

### Borrowers at Risk

The goal of this is to identify errors in the processing of eligibility of borrowers for the Making Home Affordable program and determine whether they are at risk of foreclosure.
Which Best Describes you?

### Borrower/Lender/Counselor

Which Bank did you Loan from

### Bank Of America/Wells Fargo/Chase/GMAC/None

Full Name*

### First Name Last Name

Address

### Street Address

### Street Address Line 2

### City/State/Province

### Postal/Zip Code

### Country

### Phone Number

### Area Code Phone Number

E-mail
Subject Property
   No More Than 4 units
Loan Amount
   1000000.00 (sample answer)
Date of your first Trial Amount

### /Month/Day/Year

Value of your home
   1000000.00 (sample answer)
Amount of your Principal Balance “amount you owe”
   1000000.00 (sample answer)
Owner Occupied?

### Yes/No

Upload Documents (If Any)
Needs to be Owner Occupied To Proceed further.
Back
Next
Date of Application for Making Home Affordable*

### /Month/Day/Year

Date of Denial letter for Making Home Affordable*

### /Month/Day/Year

Expiration Date of Denial Letter: *

### /Month/Day/Year

Language included in Denial Letter

### Yes/No

Reason for Denial

### NPV/Excessive Forbearance/Financial Reasons

Did Borrowers reapply

### Yes/No

SPA Agreement Reviewed

### /Month/Day/Year

Investor?

### FNMA/FHLMC

Investor Solicitation Letter Sent out (30 day) to non-participants

### /Month/Day/Year

Borrowers in Bankruptcy

### Yes/No

Chapter of Bankruptcy

### Chapter 13/7

Number of Foreclosure Postponements
   5 (sample answer)
Certification prior to foreclosure sale
Reason on Lenders Declaration
Investors guidelines and participation in HAMP in file*

### Yes/No

Scheduled Date of Foreclosure

### /Month/Day/Year

Date of Suspension Deadline for Foreclosure

### /Month/Day/Year

Submission Date of HAMP Application

### /Month/Day/Year

Date of Additional documents request

### /Month/Day/Year

California Loan?

### Yes/No

### Are you a California Resident?

### Yes/No

SUBMIT CLEAR FORM PRINT FORM
California Loans Only
   Period covered Jan. 1, 2003 to December 2008
Date of NOI (Notice of Intent)

### /Month/Day/Year

If No Contact is Made Please provide dates attempts were made

### MM/DD/YY

Date of Notice of Default

### Month/Day/Year

Date Substitution was recorded

### Month/Day/Year

Date of Trustee Notice

### Month/Day/Year

Was SB 1137 reviewed?

### Yes/No

SUBMIT CLEAR FORM PRINT FORM
California Residents Only
Were you being evaluated for a loan modification when your loan was referred to foreclosure?

### Yes/No

Were you approved for a Trial Loan Modification?

### Yes/No

How many payments did you make?
   5 (sample answer)
Date of approval

### /Month/Day/Year

Did your lender issue a denial for a loan modification?

### Yes/No

Date of Denial

### /Month/Day/Year

Did you dispute the denial within 30 days of its being issued?

### Yes/No

Was your loan a former Countrywide Loan?

### Yes/No

Did Countrywide issue a loan modification?

### Yes/No

Did you agree to a forbearance agreement after requesting a loan modification?

### Yes/No

How many forbearance payments did you make?
   5 (sample answer)
Were you promised a loan modification after completing a forbearance agreement?

### Yes/No

Was your account impounded for taxes and insurance?

### Yes/No

Did you provide your own insurance?

### Yes/No

Did the lender force homeowners insurance?

### Yes/No

Has the lender provided a escrow analysis?

### Yes/No

Are there any misapplied payments to your account which do not have an explanation?

### Yes/No

SUBMIT CLEAR FORM PRINT FORM
Test/Quiz
Number of persons signed up for the webinar
   7 (sample answer)
Number of persons taking the test
   5 (sample answer)
Department
Name of person where results of test are to be given
   5 (sample answer)
Outsourcing training being provided

### Yes/No

Name of company other than original Lender
   AB Corporation (sample answer)
   Name of Regulator Agency receiving training
   DC Corporation (sample answer)
Name of your lender
   ABC Bank (sample answer)
Lender Address

### Street Address

### Street Address Line 2

### City State/Province

### Postal/Zip Code

### Country

Loan Amount
   1000000.00 (sample answer)
   Date of your first payment?

### /Month/Day Year

Value of your Home
   1000000.00 (sample answer)
   Loan number
   5 (sample answer)
Investor Fannie Mae

### Yes/No

Investor Freddie Mac

### Yes/No

2nd Mortgage

### Yes/No

Name of 2nd Mortgage Lender
   If it the same as your first mortgage write S
Name of the servicer
   ABCD Corporation (sample answer)
Date you applied for mortgage assistance

### /Month/Day/Year

Did you apply for the MHA?

### Yes/No

Do you have a foreclosure date?

### Yes/No

Date of Foreclosure

### /Month/Day/Year

Did you request that the foreclosure be stopped?

### Yes/No

Did you speak with a Supervisor?

### Yes/No

Were you refused to be transferred to a Supervisor

### Yes/No

Date you were refused to be transferred to a Supervisor

### /Month/Day/Year

Did you receive a letter denying you for assistance?

### Yes/No

Date of the letter

### /Month/Day/Year

Did you have a single point of contact assigned to you?

### Yes/No

Name of point of contact assigned to you
   Jane Doe (sample answer)
Have you received a Forbearance Agreement?

### Yes/No

Did you receive a Trial Loan Modification?

### Yes/No

Do you pay your own insurance?

### Yes/No

Do you pay your own Real Estate taxes?

### Yes/No

Date Trial Payments began

### /Month/Day/Year

Is your housing ratio between 25% and 42%? ((example) Divide your Principal and Interest Taxes and Insurance by your Gross Monthly income. $1200.00 mortgage payment divided by $3500.00 Gross income=34% Housing Ratio)

### Yes/No

SUBMIT CLEAR FORM PRINT FORM
   Bank of America has the authority to modify Countrywide Loan
Is your loan delinquent for sixty days or more as of Jan. 31, 2012?

### Yes/No

Is your Debt to Income ratio greater than 25%?

### Yes/No

Have you received a NPV Test?

### Yes/No

Were you denied as a result of the NPV Test?

### Yes/No

Was the correct information used in the data fields?

### Yes/No

Is your property underwater?

### Yes/No

Do you live in the home as your primary residence?

### Yes/No

Refinance Opportunities
What is your current Interest Rate?
   10% (sample answer)
Is your loan an adjustable rate?

### Yes/No

Are you current on your payments for the last 12 months?

### Yes/No

Have you filed Bankruptcy or been in foreclosure within the past 24 months.?

### Yes/No

SUBMIT CLEAR FORM PRINT FORM

### Wells Fargo/Chase/GMAC:

No dual tracking:
Date of Application for Modification

### /Month/Day/Year

Date application submitted to the bank

### /Month/Day/Year

Date of Foreclosure

### /Month/Day/Year

Date of any previous denials letters

### /Month/Day/Year

Did you receive a Trial Loan Modification?

### Yes/No

Date first Trial payment began

### /Month/Day/Year

Did you receive a Notice of Default?

### Yes/No

Did you receive a Notice of Trustee Sale?

### Yes/No

Have you appealed the denial?

### Yes/No

Date of the appeal

### /Month/Day/Year

Are both borrower and co-borrower unemployed?

### Yes/No

Date of unemployment began

### /Month/Day/Year

Are you receiving unemployment benefits?

### Yes/No

Do you received Social Security Disability payments?

### Yes/No

How many contributors in your home that are not on the loan
   5 (sample answer)
SUBMIT CLEAR FORM PRINT FORM

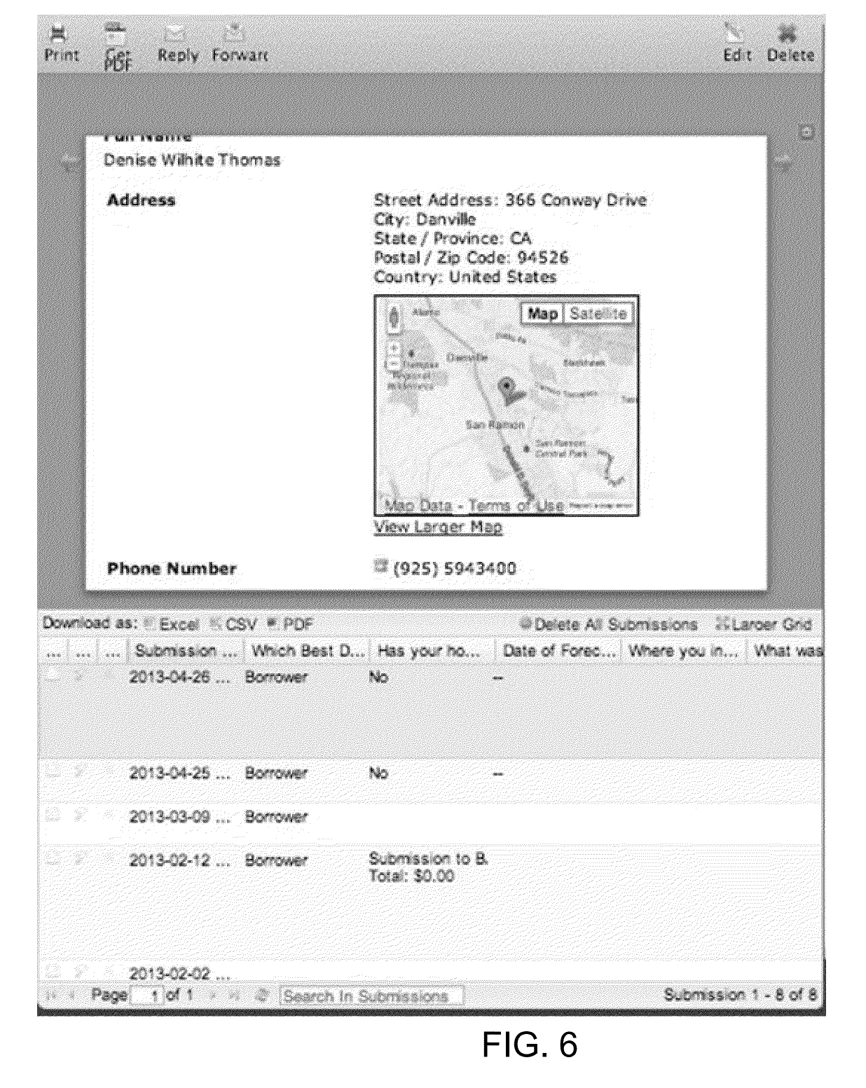

Once users submit the questionnaire that they answer, a case will be opened for each user and the inputted data and answers will be transmitted and stored at the cloud. Mobile application 200 consultants have access to cases including the inputted data, answers, analyzed information and applicant reports. FIG. 6 is a representative screen shots of applicant's report of mobile application 200 of the present invention 100. As shown in FIG. 6, mobile application 200 consultants have access to such report which will help them better analyze the case and offer accurate assessment on HAMP eligibility and other solutions to users.

Unless defined otherwise, all technical and scientific terms used herein have the same meaning as commonly understood by one of ordinary skill in the art to which the present invention belongs. Although any methods and materials similar or equivalent to those described can be used in the practice or testing of the present invention, the preferred methods and materials are now described. All publications and patent documents referenced in the present invention are incorporated herein by reference.

While the principles of the invention have been made clear in illustrative embodiments, there will be immediately obvious to those skilled in the art many modifications of structure, arrangement, proportions, the elements, materials, and components used in the practice of the invention, and otherwise, which are particularly adapted to specific environments and operative requirements without departing from those principles. The appended claims are intended to cover and embrace any and all such modifications, with the limits only of the true purview, spirit and scope of the invention.

We claim:

1. A method to identify potential borrowers/homeowners/applicants who are at risk of foreclosure and determine whether said borrower/homeowners/applicants are eligible for the National Making Home Affordable Program or other regulated loan modification program, the method comprising the following steps:
a. Obtaining information and public documents including personal particulars of borrower/applicants, property numbers, occupancy, etc.;
b. Obtaining details and documents on borrower/applicants' history of HAMP or other loan modification program application and denial;
c. Obtaining details and documents on borrower/applicants' history of HAMP or other loan modification program re-application and denial;
d. Reviewing and analyzing SPA agreement;
e. Collecting information about inventors e.g. FNMA, FHLMC, Names and making sure investor solicitation letter was sent out timely to non-participants;
f. Collecting applicants' bankruptcy history and details;
g. Obtaining details and document regarding foreclosure including postponements, notices, dates, suspension deadlines.

2. The method of claim 1, for California homeowners/applicants only, further comprises the following steps:
h. Collecting details and documents about notice of intent, notice of default, substitution recordation, Trustee notice and SB 1137 review.

3. A software application to identify potential homeowners/applicants who are at risk of foreclosure and determine whether said homeowners/applicants are eligible for the National Making Home Affordable Program or other regulated loan modification program, the mobile software application comprising:
a. means to allow users to identify their role such as borrowers, banks, consultants
b. means to obtain information and public documents including personal particulars of applicants, property numbers, occupancy, etc.;
b. means to obtain details and documents on applicants' history of HAMP or other loan modification program application and denial;
c. means to obtain details and documents on applicants' history of HAMP or other loan modification program re-application and denial;
d. means to reviewing and analyzing SPA agreement;
e. means to collecting information about inventors e.g. FNMA, FHLMC, Names and making sure investor solicitation letter was sent out timely to non-participants;
f. means to collect applicants' bankruptcy history and details;
g. means to obtain details and document regarding foreclosure including postponements, notices, dates, suspension deadlines.

4. The software application of claim 3 designed to operate on a mobile computing device.

5. The software application of claim 3 comprising one or more graphical user interfaces (GUIs), wherein the GUIs are adapted for use by target users.

6. The software application of claim 5 in which the GUIs are adapted for use by target users in the group consisting of borrowers, other applicants for a loan modification, lenders, mortgage originators, loan servicing agents, banking regulators, housing regulators, regulators of compliance with national mortgage lawsuit settlements, etc.
